(19) United States
(12) Patent Application Publication
(10) Pub. No.: US 2026/0230166 A1
(43) Pub. Date: Aug. 6, 2026

(54) SYSTEMS AND METHODS FOR ANTENNA RADIATION PATTERN MANAGEMENT FOR TERRESTRIAL AND NON-TERRESTRIAL NETWORKS

(71) Applicant: Verizon Patent and Licensing Inc., Basking Ridge, NJ (US)

(72) Inventors: Yong Sang Cho, Old Tappan, NJ (US); Andrew E. Youtz, Princeton, NJ (US); Jeremy Nacer, Boca Raton, FL (US); Lily Zhu, Parsippany, NJ (US)

(21) Appl. No.: 19/044,945

(22) Filed: Feb. 4, 2025

(51) Int. Cl. H04B 7/08; H01Q 1/28; H01Q 9/04; H04W 64/00; H04W 84/06

(52) U.S. Cl. CPC H04B 7/0814; H01Q 1/288; H01Q 9/0421; H04W 64/003; H04W 84/06

(57) ABSTRACT

A user equipment (UE) device may include a processor configured to obtain tracking information for a Non-Terrestrial Network (NTN) satellite that provides cellular wireless service for UE devices; determine a location for the UE device; and determine an orientation of the UE device. The processor may be further configured to select an NTN antenna radiation pattern, for an antenna of the UE device, based on the obtained tracking information, determined location for the UE device, and the determined orientation of the UE device; control the antenna of the UE device to generate the selected NTN antenna radiation pattern; and receive wireless signals from the NTN satellite via the antenna of the UE device using the generated NTN antenna radiation pattern.

### BACKGROUND INFORMATION

To satisfy the needs and demands of users of mobile communication devices, providers of wireless communication services continue to improve and expand their networks. One aspect of such improvements includes the development of wireless access networks and options to utilize such wireless access networks. A provider may offer services on a terrestrial wireless network and a non-terrestrial wireless network that provides coverage for areas with poor coverage by the terrestrial network. Managing communication with terrestrial and non-terrestrial wireless networks poses various challenges.

### BRIEF DESCRIPTION OF THE DRAWINGS

FIG. 1 illustrates an environment according to an implementation described herein;

FIG. 2 illustrates an exemplary antenna according to an implementation described herein;

FIG. 3 illustrates exemplary antenna radiation patterns according to an implementation described herein;

FIG. 4 illustrates adjusting an antenna radiation pattern based on tracking a satellite according to an implementation described herein;

FIG. 5 illustrates exemplary components of a device that may be included in an environment according to an implementation described herein;

FIG. 6 illustrates exemplary components of a user equipment (UE) device according to an implementation described herein;

FIG. 7 illustrates exemplary components of an antenna pattern database according to an implementation described herein;

FIG. 8 illustrates a flowchart for a process of selecting an antenna radiation pattern according to an implementation described herein;

FIG. 9 illustrates a flowchart for a process of switching from a terrestrial network antenna radiation pattern to a non-terrestrial network antenna radiation pattern according to an implementation described herein; and

FIG. 10 illustrates a flowchart for a process of switching from a non-terrestrial network antenna radiation pattern to a terrestrial network antenna radiation pattern according to an implementation described herein.

### DETAILED DESCRIPTION OF EMBODIMENTS

The following detailed description refers to the accompanying drawings. The same reference numbers in different drawings identify the same or similar elements.

A cellular wireless network enables user equipment (UE) devices to connect to networks via a Radio Access Network (RAN) and a core network in order to communicate with other devices connected to the RAN, communicate with devices in other networks, access applications or services hosted by a provider in the core network, and/or make use of other types of communication services. As cellular wireless networks and services increase in size, complexity, and number of users, management of the communication networks has become more complex. One way in which wireless networks are becoming more complicated is by incorporating various aspects of next generation networks, such as 5^{th} generation (5G) mobile networks, utilizing high frequency bands (e.g., 24 Gigahertz, 39 GHz, etc.), and/or lower frequency bands such as Sub 6 GHz, and a large number of antennas. 5G New Radio (NR) radio access technology (RAT) provides significant improvements in bandwidth and/or latency over other wireless network technology. Additionally, a 5G core network supports and manages 5G RANs that include base stations, providing various services and enabling connections to other networks (e.g., connections to the Internet, etc.). As an example, a 5G core network may provide support for enhanced Mobile Broadband (eMBB), ultra-reliable low latency communication (URLLC), massive Machine Type Communication (mMTC), and/or other types of communications.

Another enhancement to cellular wireless communication services is the deployment of non-terrestrial networks (NTNs). While a terrestrial network (TN) includes terrestrial base stations, an NTN may include satellites configured to communicate with UE devices using cellular wireless signals. An NTN satellite may function as a base station (e.g., a 5G base station) and/or as a repeater between UE devices and a terrestrial base station. NTN satellites may provide coverage in areas with poor coverage by TN base stations.

A challenge in deploying and managing NTNs is the asymmetric link budget between the uplink and downlink channel. While a satellite may include a large antenna and be able to generate a large amount of power to transmit wireless signals to UE devices, a UE device may have limited Effective Radiated Power (ERP) due to the small form factor of handheld devices and the associated small antennas. UE devices, such as handheld smartphones and/or Internet of Things (IoT) devices, may be enabled to communicate with a TN and/or an NTN on a same or different frequency bands. For example, if an NTN is available, the UE device may prefer to use the TN regardless of the presence of the NTN. On the other hand, if there is no TN available in the location of the UE device, but an NTN is available, the UE device may use the NTN. However, from the perspective of the UE device, the signal orientation between the NTN and the TN may differ significantly, due to the high elevation of the NTN satellites. Thus, antenna designs to meet the requirements of the TN and the NTN may be contradictory.

Implementations described herein relate to systems and methods for antenna radiation pattern management for TNs and NTNs. A UE device antenna may include an antenna with multiple elements that are aligned so that a short element may be controlled to perturb the radiation pattern of a longer element to generate an antenna radiation pattern that improves communication performance with an elevated transceiver, such as, for example, a wireless communication satellite. Furthermore, multiple such short elements may be located inline to perturb the antenna radiation pattern along a direction to enable the UE device to track the movement of the elevated transceiver, such as, for example, the movement of the wireless communication satellite across the sky, to thereby improve the communication performance as the position of the elevated transceiver changes.

For example, a UE device may be configured to obtain tracking information for an NTN satellite that provides cellular wireless service for UE devices, determine a location for the UE device, determine an orientation of the UE device, and select an NTN antenna radiation pattern, for an antenna of the UE device, based on the obtained tracking information, determined location for the UE device, and the determined orientation of the UE device. The UE device may then control the antenna of the UE device to generate the selected NTN antenna radiation pattern and receive wireless signals from the NTN satellite, and/or transmit wireless signals to the NTN satellite, via the antenna of the UE device using the selected NTN antenna radiation pattern.

The antenna of the UE device may include a first antenna element corresponding to at least one of a planar inverted-F antenna (PIFA) element or a monopole antenna element and a second antenna element corresponding to at least one of a planar L-shaped element or a monopole antenna element, wherein the second antenna element is shorter than the first antenna element and located substantially parallel to the first antenna element. Controlling the antenna of the UE device to generate the selected NTN antenna radiation pattern may include applying power to the second antenna element to perturb a radiation pattern associated with the first antenna element.

The antenna of the UE device may further include a third antenna element corresponding to at least one of a planar L-shaped element or a monopole antenna element, wherein the third antenna element is shorter than the first antenna element and located substantially parallel to the first antenna element and inline with the second antenna element. Controlling the antenna of the UE device to generate the selected NTN antenna radiation pattern may include tracking a position of the NTN satellite over a time period and adjusting the NTN antenna radiation pattern over the time period based on the tracked position of the NTN satellite. For example, the UE device may control the second antenna element and the third antenna element to perturb the antenna radiation pattern along a longitudinal direction of the first antenna element to track the position of the NTN satellite.

In some implementations, the UE device may include multiple sets of long and short antenna elements positioned in planes that are perpendicular to each other. For example, the UE device may include a first antenna element corresponding to a long PIFA or monopole antenna element, a second antenna element corresponding to a short planar L-shaped or monopole antenna element and located substantially parallel to the first antenna element, a third antenna element corresponding to a long PIFA or monopole antenna element, and a fourth antenna element corresponding to a short planar L-shaped or monopole antenna element and located substantially parallel to the fourth antenna element, wherein the planar orientation of the third and fourth antenna elements is perpendicular to a planar orientation of the first and second antenna elements. Having multiple sets of long and short antenna elements positioned in planes that are specifically oriented to each other may enable the UE device to select a particular set of long and short antenna elements based on the orientation of the UE device so that a resulting NTN antenna radiation pattern points toward an NTN satellite without having to adjust the NTN antenna radiation pattern based on the orientation of the UE device.

Furthermore, the UE device may be configured to maintain a TN antenna radiation pattern when the UE device is connected to a TN. The TN antenna radiation pattern may be controlled without applying a perturbation based on the tracking information for the NTN satellite. The UE device may be further configured to switch to the NTN antenna radiation pattern to measure a signal strength or quality associated with the NTN satellite and switch back to the TN antenna radiation pattern during a measurement gap associated with the NTN satellite. If the UE device determines that a handover to the NTN is to be performed, the UE device may switch to the NTN antenna pattern. Similarly, when the UE device is connected to the NTN, the UE device may switch to the TN antenna radiation pattern to measure a signal strength or quality associated with the TN and switch back to the NTN antenna radiation pattern during a measurement gap associated with the TN.

Moreover, the UE device may be configured to detect that the UE device has entered an NTN-only coverage location, switch to the NTN antenna radiation pattern, based on detecting that the UE device has entered the NTN-only coverage location, and connect to the NTN satellite using the NTN antenna radiation pattern. Detecting that the UE device has entered the NTN-only coverage location may include detecting a geofence associated with the NTN-only coverage area. The UE device may be further configured to detect that the UE device has exited an NTN-only coverage location, switch to the TN antenna radiation pattern, based on detecting that the UE device has exited the NTN-only coverage location, and connect to the TN using the TN antenna radiation pattern.

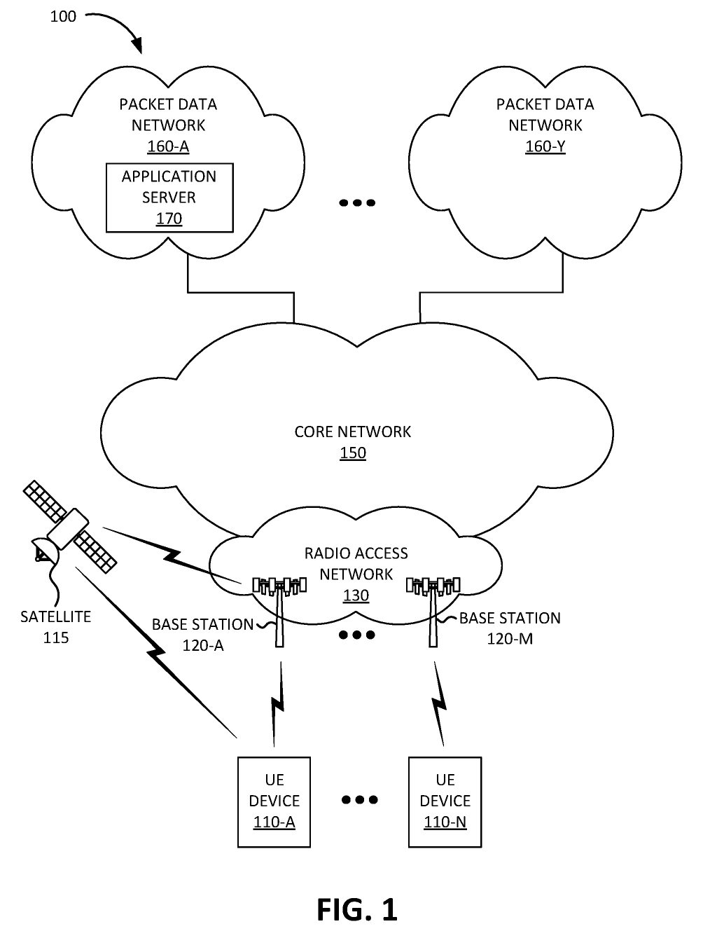

FIG. 1 is a diagram of an exemplary environment 100 in which the systems and/or methods described herein may be implemented. As shown in FIG. 1, environment 100 may include UE devices 110-A to 110-N (herein collectively referred to as “UE devices 110” and individually as “UE device 110”), a satellite 115 and base stations 120-A to 120-M (herein collectively referred to as “base stations 120” and individually as “base station 120”) in RAN 130, core network 150, and packet data networks (PDNs) 160-A to 160-Y (herein collectively referred to as “PDNs 160” and individually as “PDN 160”).

UE device 110 may include any device with cellular wireless communication functionality. For example, UE device 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); a laptop computer, a tablet computer, or another type of portable computer; a desktop computer; a customer premises equipment (CPE) device, such as a set-top box or a digital media player (e.g., Apple TV, Google Chromecast, Amazon Fire TV, etc.), a WI-FI access point, a fixed wireless access device, a smart television, etc.; a portable gaming system; a global positioning system (GPS) device; a home appliance device; a home monitoring device; and/or any other type of computer device with wireless communication capabilities. In some implementations, UE device 110 may communicate using machine-to-machine (M2M) communication, such as Machine Type Communication (MTC), and/or another type of M2M communication for IoT applications.

UE device 110 may be enabled for communicating with a TN via base station 120 and for communicating with an NTN via satellite 115. As an example, UE device 110 may include a first radio frequency (RF) transceiver, communication interface, modem, and/or chipset for communicating with base station 120 and a second RF transceiver, communication interface, modem, and/or chipset for communicating with satellite 115. The first RF transceiver and the second RF transceiver may use the same antenna. In other implementations, UE device 110 may use the same RF transceiver and antenna for the TN and the NTN.

RAN 130 may include base stations 120 and satellite 115. Satellite 115 may include a wireless transceiver configured to communicate using a specific frequency band such as a Kₐ band, for example. An NTN Kₐ band may be defined as a single fully harmonized earth-to-space band in the 27.5-30.0 GHz range with specific network signaling to address region-specific requirements and restrictions, and/or additional bands in the 27.5-28.35 GHz range and in the 28.35-30.0 GHz range for the United States and subject to regulations by the Federal Communications Commission (FCC). In some implementations, satellite 115 may function as a repeater, for a particular base station 120, that retransmits signals from the particular base station 120 to UE devices 110 registered with the particular base station 120 and/or retransmit signals from UE devices 110 registered with the particular base station 120 to the particular base station 120. In other implementations, satellite 115 may include the functionality of base station 120. Satellite 115 may include a low Earth orbit (LEO) satellite, a geosynchronous satellite, a medium Earth orbit (MEO) satellite, and/or another type of satellite. While a single satellite 115 is shown in FIG. 1 for illustrative purposes, in practice, RAN 130 may include multiple satellites 115. Satellites 115 and base stations 120 of RAN 130 for which satellites 115 function as repeaters correspond to an NTN. Other base stations 120 of RAN 130 that do not use satellites 115 as repeaters correspond to a TN. Satellite 115 may be controlled and/or managed by a provider of communication services that may be the same as, or different than, the provider associated with a TN.

Base station 120 may be configured for one or more RAT types. For example, base station 120 may include a 5G NR base station (e.g., a gNodeB) and/or a Fourth Generation (4G) Long Term Evolution (LTE) base station (e.g., an eNodeB). Each base station 120 may include devices and/or components that enable cellular wireless communication with UE devices 110. For example, base station 120 may include an RF transceiver configured to communicate with UE devices 110 using a 5G NR air interface, a 4G LTE air interface, and/or using another type of cellular air interface. Base station 120 may enable UE device 110 to communicate with core network 150.

Core network 150 may be managed by a provider of cellular wireless communication services and may manage communication sessions of subscribers connecting to core network 150 via RAN 130. For example, core network 150 may establish an Internet Protocol (IP) connection between UE devices 110 and PDN 160. In some implementations, core network 150 may include a 5G core network. In other implementations, core network 150 may include a 4G core network (e.g., an evolved packet core (EPC) network) and/or another type of core network.

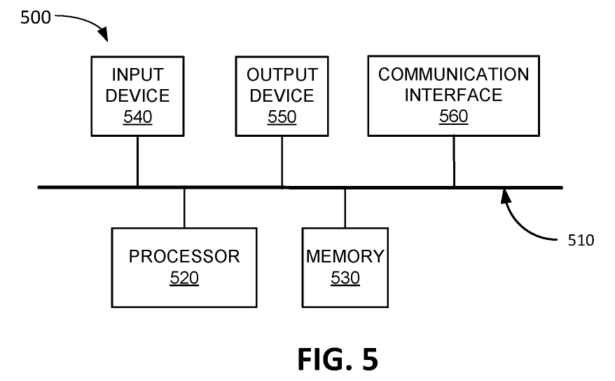

The components of core network 150 may be implemented as dedicated hardware components or as virtualized functions implemented on top of a common shared physical infrastructure using Software Defined Networking (SDN). For example, an SDN controller may implement one or more of the components of core network 150 using an adapter implementing a virtual network function (VNF) virtual machine, a Cloud Native Function (CNF) container, an event driven serverless architecture interface, and/or another type of SDN component. The common shared physical infrastructure may be implemented using one or more devices 500 described below with reference to FIG. 5 in a cloud computing center associated with core network 150.

PDNs 160-A to 160-Y may each include a PDN. A particular PDN 160 may be associated with a Data Network Name (DNN) in 5G, and/or an Access Point Name (APN) in 4G. A UE device may request a connection to PDN 160 using a DNN or an APN. PDN 160 may include, and/or be connected to, a local area network (LAN), a wide area network (WAN), a metropolitan area network (MAN), an autonomous system (AS) on the Internet, an optical network, a cable television network, a satellite network, a wireless network (e.g., a CDMA network, a general packet radio service (GPRS) network, and/or an LTE network), an ad hoc network, a telephone network (e.g., the Public Switched Telephone Network (PSTN) or a cellular network), an intranet, or a combination of networks.

PDN 160 may include an application server 170 (shown in PDN 160-A in FIG. 1 for illustrative purposes). Application server 170 may provide services for an application running on UE device 110 and may establish an application session with UE device 10 via RAN 130 and core network 150. RAN 130 and core network 150 may establish a communication session or data flow between UE device 110 and application server 170.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

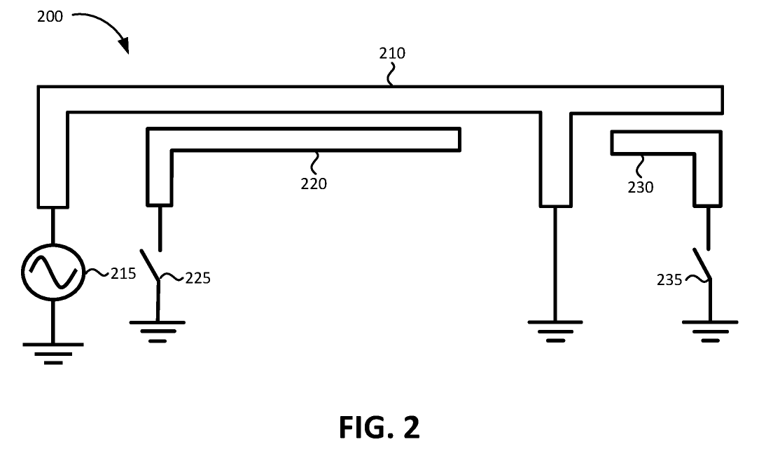

FIG. 2 illustrates an exemplary antenna 200. Antenna 200 may be included in UE device 110 and used for communicating with satellite 115 and/or base station 120. As shown in FIG. 2, antenna 200 may include a long element 210, a power source 215, a first short element 220, a first switch 225, a second short element 230, and a second switch 235.

Long element 210, first short element 220, and second short element 230 may each correspond to a planar antenna metallic element positioned in substantially the same plane with respect to each other. Long element 210, first short element 220, and second short element 230 may each be implemented in a microstrip on a printed circuit board associated with an RF transceiver included in UE device 110.

Long element 210 may correspond to a PIFA element with a long bar (e.g., horizontal portion of long element 210 in FIG. 2), a first short arm connected to power source 215, and a second short arm connected to ground (e.g., vertical portions of long element 210 in FIG. 2). In other implementations, the first short arm may be connected to ground and the second short arm may be connected to power source 215. Furthermore, in other implementation, long element 210 may correspond to a monopole antenna element that only includes a long bar connected to power source 215.

First short element 220 may corresponds to an L-shaped planar antenna element with a long bar (e.g., horizontal portion of first short element 220 in FIG. 2) and a short arm connected to first switch 225 (e.g., vertical portion of first short element 220 in FIG. 2). In other implementations, first switch 225 may be connected to the long bar of first short element 220. Furthermore, in other implementations, first short element 220 may correspond to a monopole antenna element that only includes a long bar connected to first switch 225.

Second short element 230 may correspond to an L-shaped planar antenna element with a long bar (e.g., horizontal portion of second short element 230 in FIG. 2) and a short arm connected to second switch 235 (e.g., vertical portion of second short element 230 in FIG. 2). In other implementations, second switch 235 may be connected to the long bar of second short element 230. Furthermore, in other implementations, second short element 230 may correspond to a monopole antenna element that only includes a long bar connected to second switch 235.

First short element 220 and second short element 230 may be coplanar with long element 210. The long bar of first short element 220 and the long bar of second short element 230 may be substantially parallel to the long bar of long element 210. The long bar of first short element 220 and the long bar of second short element 230 may be inline (e.g., substantially collinear, etc.) with each other. Furthermore, the long bar of first short element 220 and the long bar of second short element 230 may be each be shorter than the long bar of long element 210. Additionally, the long bar of second short element 230 may be shorter than the long bar of first short element 220. For example, the long bar of first short element 220 may fit between the first short arm and second short arm of long element 210 while being electrically isolated from long element 210. As another example, the long bar of second short element 230 may fit between an end of the long bar of long element 210 and the second short arm of long element 210 while being electrically isolated from long element 210.

First switch 225 may be implemented as part of a switch matrix and may connect first short element 220 to ground. First switch 225 may control power applied to first short element 220 to perturb the antenna radiation pattern of long element 210. For example, when first switch 225 is closed and power is applied to first short element 220, the antenna radiation pattern of long element 210 may be perturbed toward the location of first short element 220. Second switch 235 may be implemented as part of a switch matrix and may connect second short element 230 to ground. Second switch 235 may control power applied to second short element 230 to perturb the antenna radiation pattern of long element 210. For example, when second switch 235 is closed and power is applied to second short element 230, the antenna radiation pattern of long element 210 may be perturbed toward the location of second short element 230.

Although FIG. 2 shows exemplary components of antenna 200, in other implementations, antenna 200 may include fewer components, different components, differently arranged components, or additional components than depicted in FIG. 2. Additionally, or alternatively, one or more components of antenna 200 may perform functions described as being performed by one or more other components of antenna 200.

For example, in some implementations, antenna 200 may include first short element 220 without second short element 230, or, alternatively, may include second short element 230 without first short element 220. As another example, UE device 110 may include multiple antennas 200. In some implementations, the multiple antennas 200 may be coplanar. In other implementations, the multiple antennas 200 may be positioned in planes that are perpendicular with each other. For example, a first antenna 200 may be positioned to be parallel to, and/or in the same plane as, a plane of a circuit board of UE device 110 (e.g., a circuit board that is in a plane parallel to the front face and/or the back face of UE device 110, etc.), and a second antenna 200 may be positioned in a plane that is perpendicular to the first antenna 200. Multiple antennas 220 that are positioned in planes that are perpendicular to each other may enable UE device 110 to select an antenna from the multiple antennas 200 so that an NTN antenna radiation pattern points toward satellite 115.

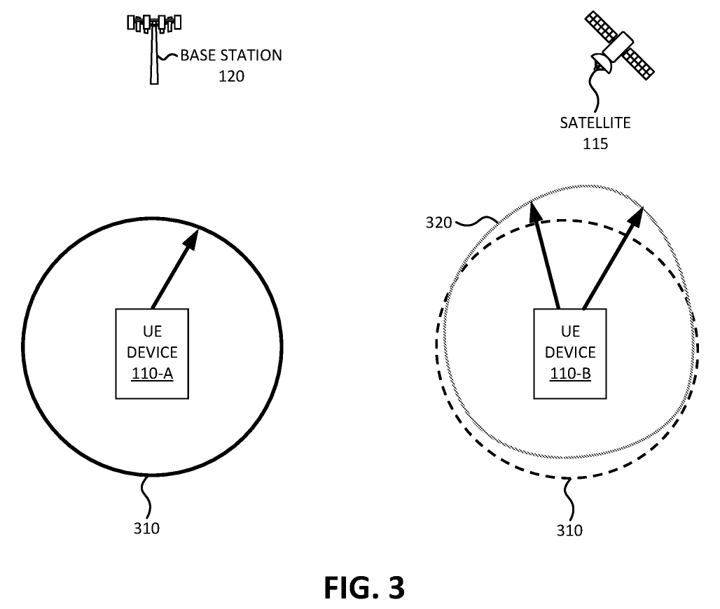

FIG. 3 illustrates exemplary antenna radiation patterns. As shown in FIG. 3, UE device 110-A may be connected to base station 120 using a TN antenna radiation pattern 310. TN antenna radiation pattern 310 may be non-directional and thus optimized for communicating with base stations 120. TN antenna radiation pattern 310 may be generated by not applying power to first short element 220 or to second short element 230 (e.g., by keeping first switch 225 and second switch 235 open, etc.) and leaving the antenna radiation pattern generated by long element 210 unperturbed.

UE device 110-B may be connected to satellite 115 using an NTN radiation pattern 320. TN radiation pattern 310 is shown as dashed lines to more clearly illustrate the difference between TN radiation pattern 310 and NTN radiation pattern 320. NTN antenna radiation pattern 320 may be optimized for communicating with satellite 115 by exhibiting a directional radiation pattern directed toward the position of satellite 115. NTN antenna radiation pattern 320 may be generated by applying power to first short element 220 and/or to second short element 230 (e.g., by closing first switch 225 and/or second switch 235, etc.) and perturbing the antenna radiation pattern generated by long element 210.

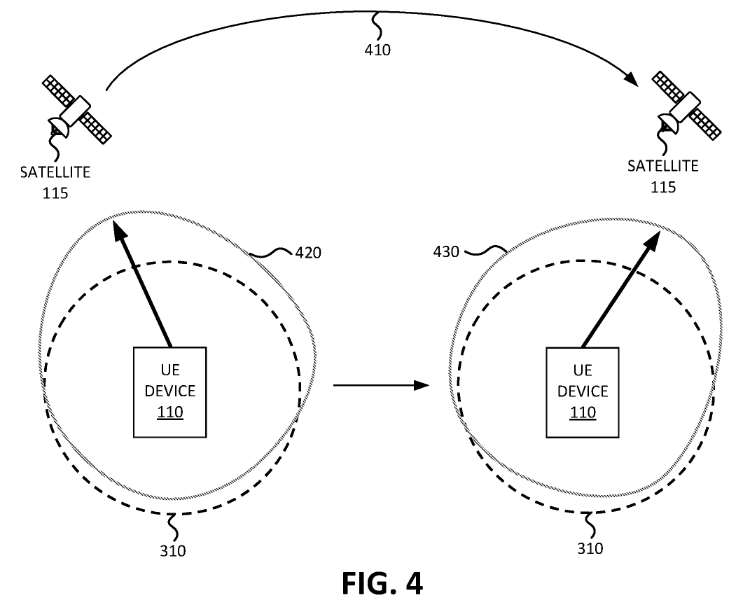

FIG. 4 illustrates adjusting an antenna radiation pattern based on tracking a satellite. As shown in FIG. 4, satellite 115 may follow a trajectory 410 across the sky. Additionally, or alternatively (not shown in FIG. 4), UE device 110 may change its location with respect to satellite 115 when UE device 110 is in motion. UE device 110 may change an NTN antenna radiation pattern 420 to NTN antenna radiation pattern 430 to follow trajectory 410. TN radiation pattern 310 is shown as dashed lines to more clearly illustrate the difference between TN radiation pattern 310 and NTN radiation patterns 420 and 430. NTN antenna radiation pattern 420 may be generated by applying more power to first short element 220 than to second short element 230 and thereby perturbing the antenna radiation pattern generated by long element 210. NTN antenna radiation pattern 430 may be generated by applying more power to second short element 230 than to first short element 220 and thereby perturbing the antenna radiation pattern generated by long element 210.

UE device 110 may receive ephemeris information from satellite 115 via a System Information Block (SIB) transmitted by satellite 115 and calculate the location of satellite 115 and neighboring satellites 115 based on the received ephemeris information. UE device 110 may further calculate the location and/or relative orientation of UE device 110 with respect to satellite 115 using a GPS receiver and/or sensors included in UE device 110, such as, for example, an accelerometer and/or magnetic sensors. UE device 110 may then keep track of its relative orientation with respect to satellite 115 as well as the azimuth and elevation angles of satellite 115 with respect to the location of UE device 110. UE device 110 may then select an NTN antenna radiation pattern to maximize the ERP in the direction toward satellite 115 and may change the NTN radiation pattern at particular intervals to track the relative position of satellite 115 with respect to the position of UE device 110.

FIG. 5 illustrates example components of a device 200 according to an implementation described herein. UE device 110, satellite 115, base station 120, application server 170, and/or other components of core network 150 or RAN 130, may each include one or more devices 500. As shown in FIG. 5, device 500 may include a bus 510, a processor 520, a memory 530, an input device 540, an output device 550, and a communication interface 560.

Bus 510 may include a path that permits communication among the components of device 500. Processor 520 may include any type of single-core processor, multi-core processor, microprocessor, latch-based processor, central processing unit (CPU), and/or processing logic (or families of processors, microprocessors, and/or processing logics) that interprets and executes instructions. In other embodiments, processor 520 may include an application-specific integrated circuit (ASIC), a field-programmable gate array (FPGA), and/or another type of integrated circuit or processing logic. Additionally, or alternatively, processor 220 may include a hardware accelerator integrated circuit or processing logic, such as a graphics processing unit (GPU), a tensor processing unit (TPU), quantum annealing processor, and/or another type of hardware accelerator.

Memory 530 may include any type of dynamic storage device that may store information and/or instructions, for execution by processor 520, and/or any type of non-volatile storage device that may store information for use by processor 520. For example, memory 530 may include a random-access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 540 may allow an operator to input information into device 500. Input device 540 may include, for example, a keyboard, a mouse, a pen, a microphone, a remote control, an audio capture device, an image and/or video capture device, a touch-screen display, and/or another type of input device. In some embodiments, device 500 may be managed remotely and may not include input device 540. In other words, device 500 may be “headless” and may not include a keyboard, for example.

Output device 550 may output information to an operator of device 500. Output device 550 may include a display, a printer, a speaker, and/or another type of output device. For example, device 500 may include a display, which may include a liquid-crystal display (LCD) for displaying content to the customer. In some embodiments, device 500 may be managed remotely and may not include output device 550. In other words, device 500 may be “headless” and may not include a display, for example.

Communication interface 560 may include a transceiver that enables device 500 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 560 may include a transmitter that converts baseband signals to RF signals and/or a receiver that converts RF signals to baseband signals. Communication interface 560 may be coupled to one or more antennas/antenna arrays for transmitting and receiving RF signals.

Communication interface 560 may include a logical component that includes input and/or output ports, input and/or output systems, and/or other input and output components that facilitate the transmission of data to other devices. For example, communication interface 560 may include a network interface card (e.g., Ethernet card) for wired communications and/or a wireless network interface (e.g., a WiFi) card for wireless communications. Communication interface 560 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 500 may perform certain operations relating to managing interference between a TN and an NTN using the same spectrum. Device 500 may perform these operations in response to processor 520 executing software instructions contained in a computer-readable medium, such as memory 530. A computer-readable medium may be defined as a non-transitory memory device. A memory device may be implemented within a single physical memory device or spread across multiple physical memory devices. The software instructions may be read into memory 530 from another computer-readable medium or from another device. The software instructions contained in memory 530 may cause processor 520 to perform processes described herein. Alternatively, hardwired circuitry may be used in place of, or in combination with, software instructions to implement processes described herein. Thus, implementations described herein are not limited to any specific combination of hardware circuitry and software.

Although FIG. 5 shows exemplary components of device 500, in other implementations, device 500 may include fewer components, different components, additional components, or differently arranged components than depicted in FIG. 5. Additionally, or alternatively, one or more components of device 500 may perform one or more tasks described as being performed by one or more other components of device 500.

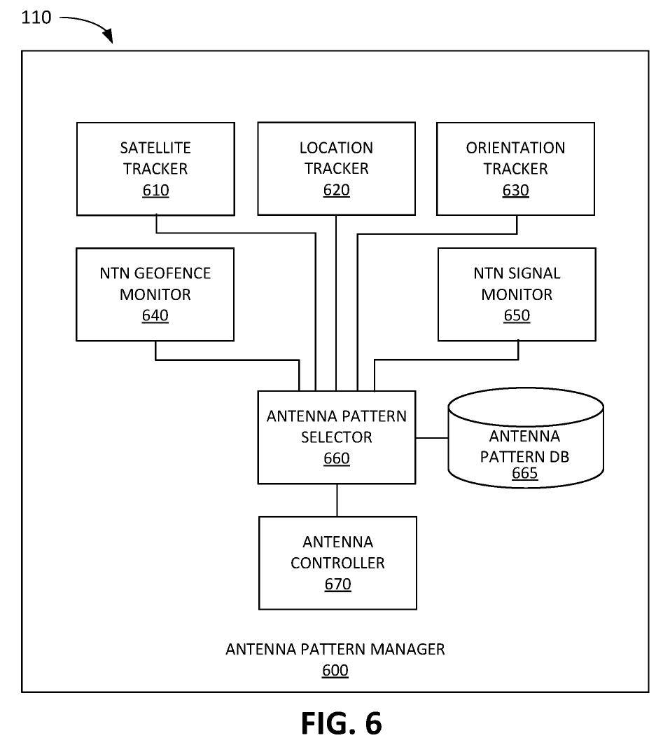

FIG. 6 is a diagram illustrating exemplary components of UE device 110. The components of UE device 110 may be implemented, for example, via processor 620 executing instructions from memory 630. Alternatively, some or all of the components of UE device 110 may be implemented via hard-wired circuitry. As shown in FIG. 6, UE device 110 may include an antenna pattern manager 600. Antenna pattern manager 600 may manage the antenna radiation pattern of antenna 200. Antenna pattern manager 600 may include a satellite tracker 610, a location tracker 620, an orientation tracker 630, an NTN geofence monitor 640, an NTN signal monitor 650, an antenna pattern selector 660, an antenna pattern database (DB) 665, and an antenna controller 670.

Satellite tracker 610 may track the positions of satellites 115. For example, satellite tracker 610 may, at particular intervals, scan for a SIB transmitted by satellite 115. Satellite tracker 610 may receive a SIB from satellite 115, extract ephemeris information for satellite 115 from the SIB, and determine the position, and/or direction/speed of movement, for satellite 115. Satellite tracker 610 may provide the position and/or direction/speed of movement of satellite 115 to antenna pattern selector 660.

Location tracker 620 may determine a current position, and/or direction/speed of movement, of UE device 110, using information obtained from a GPS receiver included in UE device 110 and/or using other types of information, such as multilateration information obtained from base stations 120. Location tracker 620 may provide the current position and/or direction/speed of movement of UE device 110 to antenna pattern selector 660.

Orientation tracker 630 may determine a current orientation of UE device 110 using one or more sensors included in UE device 110, such as an accelerometer, gyroscope, magnetometer, and/or another type of sensor that may be used to determine an orientation of UE device 110. Orientation may refer to the position of a particular axis and/or plane of UE device 110 with respect to the ground (e.g., a ground plane based on the surface of the Earth, etc.). For example, the orientation may refer to an angle between a line, which is coplanar with, and perpendicular to, long element 210 of antenna 200, and a plane that is tangential to the surface of the Earth and perpendicular to a line from the center of the Earth to the location of UE device 110. In some implementations, the orientation may be designated as horizontal versus vertical orientation. In other implementations, the orientation may be expressed as an elevation angle. Orientation tracker 630 may provide the determined orientation information to antenna pattern selector 660.

NTN geofence monitor 640 may monitor for an NTN geofence. An NTN geofence may indicate the boundaries of a geographic area designated as an NTN-only area. An NTN-only area may correspond to an area that is known to not have satisfactory TN coverage and may rely on NTN coverage to provide service to UE devices 110. Thus, UE devices 110 in the NTN-only area may be instructed by the provider to connect to the NTN via satellite 115. NTN geofence monitor 640 provide information indicating whether UE device 110 is located in an NTN-only area to antenna pattern selector 660.

NTN signal monitor 650 may monitor for the signal strength and/or quality associated with satellite 115 to determine whether to connect to an NTN or disconnect from an NTN. For example, NTN signal monitor 650 may provide a measurement report to a serving base station, such as base station 120 and/or satellite 115, to which UE device 110 is connected, and may receive an instruction from the serving base station as to whether to perform a handover or a redirect from a TN to an NTN or from an NTN to a TN. NTN signal monitor 650 may provide the handover or redirect information to antenna pattern selector 660.

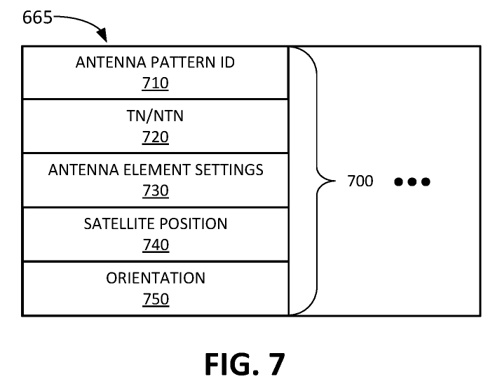

Antenna pattern selector 660 may select an antenna radiation pattern for antenna 220 based on information received from satellite tracker 610, location tracker 620, orientation tracker 630, NTN geofence monitor 640, and/or NTN signal monitor 650, and based on information stored in antenna pattern DB 665. Antenna pattern DB 665 may store information associated with particular antenna radiation patterns. Exemplary information that may be stored in antenna pattern DB is described below with reference to FIG. 7.

Antenna pattern selector 660 may determine whether to select a TN antenna radiation pattern or an NTN antenna radiation pattern. Antenna pattern selector 660 may select a TN antenna radiation pattern when UE device 110 is connected to a TN, when UE device 110 is connected to an NTN and needs to perform a measurement of signals from the TN, when UE device 110 is connected to the NTN and needs to perform a handover or a redirect to the TN, and/or when UE device 110 is not in an NTN-only area. Antenna pattern selector 660 may select an NTN antenna radiation pattern when UE device 110 is connected to an NTN, when UE device 110 is connected to a TN and needs to perform a measurement of signals from the NTN, when UE device 110 is connected to the TN and needs to perform a handover or a redirect to the NTN, and/or when UE device 110 is in an NTN-only area.

If antenna pattern selector 660 selects an NTN antenna radiation pattern, antenna pattern selector 660 may select a particular NTN antenna radiation pattern based on the location and/or movement of satellite 115, the location and/or movement of UE device 110, and/or the orientation of UE device 110. For example, antenna pattern selector 660 may determine an azimuth angle and an elevation angle from UE device 110 to satellite 115 based on the position of UE device 110 and satellite 115. Antenna pattern selector 660 may determine an antenna radiation pattern that is perturbed in the direction of a vector from UE device 110 to satellite 115 based on the determined azimuth and elevation angles and may further modify the determined antenna radiation pattern based on the orientation of UE device 110. For example, the orientation of UE device 110 may be considered optimal if an orientation line, which is coplanar with, and perpendicular to, long element 210 of antenna 200, is in the same direction as the vector from UE device 110 to satellite 115. If the orientation of UE device 110 is in an angle that is higher or lower than the elevation angle of the vector from UE device 110 to satellite 115, antenna pattern selector 660 may select an antenna radiation pattern that is perturbed in the direction of the vector from the orientation line of UE device 110.

Furthermore, antenna pattern selector 660 may track the position of satellite 115 and may, at particular intervals, update the NTN antenna radiation pattern to be perturbed in the direction of satellite 115. Stated differently, antenna pattern selector 660 may track satellite 115 and adjust, at particular intervals, NTN antenna radiation pattern 320 in the direction of satellite 115 (e.g., from NTN antenna radiation pattern 420 to NTN antenna radiation pattern 430, etc.). In some implementations, antenna pattern selector 660 may anticipate the vector from UE device 110 to satellite 115 based on a trajectory of movement of satellite 115 and/or based on a trajectory of movement of UE device 110, and may adjust NTN antenna radiation pattern 320 in real-time.

Antenna controller 670 may control antenna 200 to generate a particular antenna radiation pattern. For example, antenna controller 670 may apply power pulses of particular amplitude, duration, and/or frequency to long element, first short element 220, and/or second short element 230 based on a selected antenna radiation pattern and on information stored in antenna pattern DB 665.

Although FIG. 6 shows exemplary components of UE device 110, in other implementations, UE device 110 may include fewer components, different components, additional components, or differently arranged components than depicted in FIG. 6. Additionally, or alternatively, one or more components of UE device 110 may perform one or more tasks described as being performed by one or more other components of UE device 110.

FIG. 7 illustrates exemplary components of antenna pattern DB 665 according to an implementation described herein. As shown in FIG. 7, antenna pattern DB 665 may include one or more antenna pattern records 700. Each antenna pattern record 700 may store information associated with a particular antenna radiation pattern that may be generated by antenna 200 in response to controls applied to switches 225 and/or 235. Antenna pattern record 700 may include an antenna radiation pattern identifier (ID) field 710, an NT/TNT field 720, an antenna elements settings field 730, a satellite position field 740, and an orientation field 750.

Antenna pattern ID field 710 may store an ID associated with a particular antenna radiation pattern. NT/TNT field 720 may store information indicating whether the particular antenna radiation pattern is optimized for TN communication or NTN communication. Antenna elements settings field 730 may store information identifying amplitude, duration, and/or frequency settings to be applied to long element, first short element 220, and/or second short element 230.

Satellite position field 740 may identify a satellite position associated with the particular antenna radiation pattern. For example, satellite position field 740 may identify a range of azimuth angles and/or a range of elevation angles for a vector from a position of UE device 110 to a position of satellite 115, for which the particular antenna radiation patterns should be selected. Orientation field 750 may store information identifying one or more orientations of UE device 110 associated with the particular antenna radiation pattern. For example, orientation field 750 may identify a horizontal orientation of UE device 110 in which the front face of UE device 110 is parallel with the ground, a vertical orientation of UE device 110 in which the front face of UE device 110 is perpendicular to the ground, etc. As another example, orientation field 750 may identify a range of azimuth angles and/or a range of elevation angles for a particular axis of UE device 110 (e.g., an axis running across a longitudinal direction of front face of UE device, etc.).

Although FIG. 7 shows exemplary components of antenna pattern DB 665, in other implementations, antenna pattern DB 665 may store fewer components, different components, additional components, or differently arranged components than depicted in FIG. 7.

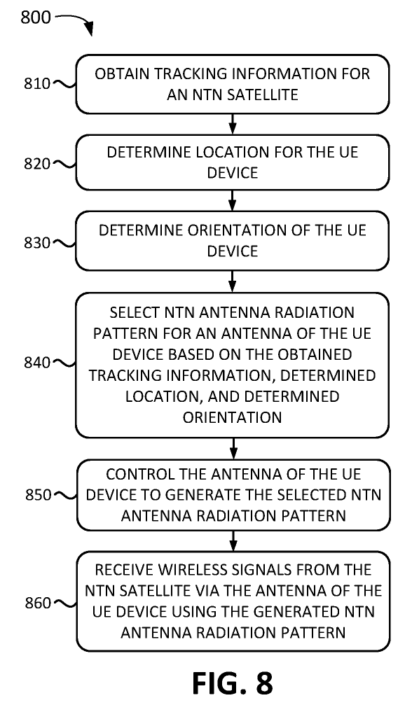

FIG. 8 illustrates a flowchart for a process 800 of selecting an antenna radiation pattern according to an implementation described herein. In some implementations, the process of FIG. 8 may be performed by UE device 110. In other implementations, some or all of the process of FIG. 8 may be performed by another device or a group of devices separate from UE device 110.

Process 800 may include obtaining tracking information for an NTN satellite (block 810). For example, UE device 110 may, at particular intervals, scan for a SIB transmitted by satellite 115. UE device 110 may receive a SIB from satellite 115, extract ephemeris information for satellite 115 from the SIB, and determine the position, and/or direction/speed of movement, for satellite 115.

Process 800 may further include determining a location of the UE device (block 820) and determining an orientation of the UE device (block 830). For example, UE device 110 may determine a current position, and/or direction/speed of movement, for UE device 110 using information obtained from a GPS receiver included in UE device 110 and/or using other types of information, such as multilateration information obtained from base stations 120. UE device 110 may further determine a current orientation of UE device 110 using one or more sensors included in UE device 110, such as an accelerometer, gyroscope, magnetometer, and/or another type of sensor that may be used to determine an orientation of UE device 110. The orientation may refer, for example, to an angle between a line, which is coplanar with, and perpendicular to, long element 210 of antenna 200, and a plane that is tangential to the surface of the Earth and perpendicular to a line from the center of the Earth to the location of UE device 110.

Process 800 may further include selecting an NTN antenna radiation pattern for an antenna of the UE device based on the obtained tracking information, determined location, and determined orientation (block 840). For example, UE device 110 may select an NTN antenna radiation pattern when UE device 110 is connected to an NTN, when UE device 110 is connected to a TN and needs to perform a measurement of signals from the NTN, when UE device 110 is connected to the TN and needs to perform a handover or a redirect to the NTN, and/or when UE device 110 is in an NTN-only area. UE device 110 may select a particular NTN antenna radiation pattern based on the location and/or movement of satellite 115, the location and/or movement of UE device 110, and/or the orientation of UE device 110. For example, UE device 110 may determine an azimuth angle and an elevation angle from UE device 110 to satellite 115 based on the position of UE device 110 and satellite 115. UE device 110 may further determine an antenna radiation pattern that is perturbed in the direction of a vector from UE device 110 to satellite 115 based on the determined azimuth and elevation angles and may further modify the determined antenna radiation pattern based on the orientation of UE device 110. For example, UE device 110 may select an antenna radiation pattern that is perturbed in the direction of the vector from UE device 110 to satellite 115 from an orientation line of UE device 110.

Process 800 may further include controlling the antenna of the UE device to generate the selected NTN antenna radiation pattern (block 850) and receiving wireless signals from the NTN satellite via the antenna of the UE device using the generated NTN antenna radiation pattern (block 860). For example, UE device 110 may control antenna 200 to generate a particular antenna radiation pattern by applying power pulses of particular amplitude, duration, and/or frequency to long element 210, first short element 220, and/or second short element 230 based on the selected antenna radiation pattern. UE device 110 may then receive wireless signals from satellite 115 using antenna 200 and/or may transmit wireless signals to satellite 115 using antenna 200.

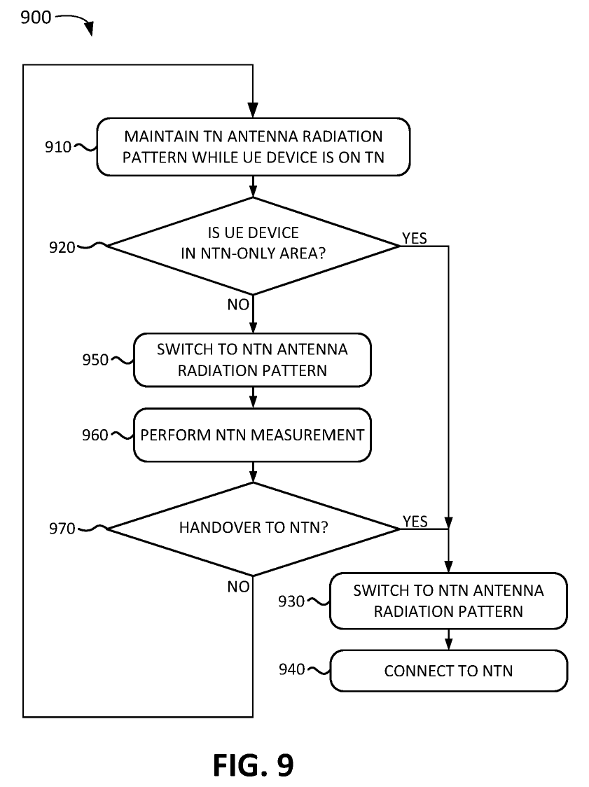

FIG. 9 illustrates a flowchart for a process 900 of switching from a TN antenna radiation pattern to an NTN antenna radiation pattern according to an implementation described herein. In some implementations, the process of FIG. 9 may be performed by UE device 110. In other implementations, some or all of the process of FIG. 9 may be performed by another device or a group of devices separate from UE device 110.

Process 900 may include maintaining a TN antenna radiation pattern while the UE device is on a TN (block 910). For example, when UE device 110 is connected to base station 120 (e.g., attached to base station 120, registered with base station 120, etc.), UE device 110 may maintain TN radiation pattern 310. A determination may be made as to whether the UE device is in an NTN-only area (block 920). As an example, UE device 110 may determine whether an NTN-only area geofence has been crossed and/or whether UE device 110 is located in an area that is inside an NTN-only area geofence. UE device 110 may detect an NTN-only area geofence by receiving an alert from core network 150 based on the location of UE device 110, by receiving an internal alert from an application or service, running on UE device 110, that is configured with an NTN-only area geofence database, and/or based on receiving another type of indication that UE device 110 is located in an NTN-only area.

If it is determined that the UE device is in an NTN-only area (block 920 – YES), processing may proceed to switch to an NTN antenna radiation pattern (block 930), and connecting to the NTN (block 940). For example, in response to detecting an NTN-only area geofence, UE device 110 may switch from TN antenna radiation pattern 310 to NTN antenna radiation pattern 320 and may perform a handover or redirect from the TN to the NTN by connecting to satellite 115 and disconnecting from base station 120.

If it is determined that the UE device is not in an NTN-only area (block 920 – NO), processing may proceed to switch to an NTN antenna radiation pattern (block 950) and performing an NTN measurement (block 960). For example, at particular measurement intervals, UE device 110 may switch from TN antenna radiation pattern 310 to NTN antenna radiation pattern 320, perform a signal strength and/or quality measurement, and send a measurement report to satellite 115. UE device 110 may switch back to TN antenna radiation pattern 310 during the measurement gap.

A determination may be made as to whether a handover to the NTN is to be performed (block 970). For example, UE device 110 may receive an instruction from base station 120 to perform a handover (or a redirect) to satellite 115. If it is determined that the handover to the NTN is to be performed (block 970 – YES), processing may proceed to switch to an NTN antenna radiation pattern (block 930), and connecting to the NTN (block 940). For example, UE device 110 may switch from TN antenna radiation pattern 310 to NTN antenna radiation pattern 320 and may perform a handover or redirect from the TN to the NTN by connecting to satellite 115 and disconnecting from base station 120.

If it is determined that the handover to the NTN is not to be performed (block 970 – NO), processing may return to block 910 to maintain the TN antenna radiation pattern while the UE device is on the TN.

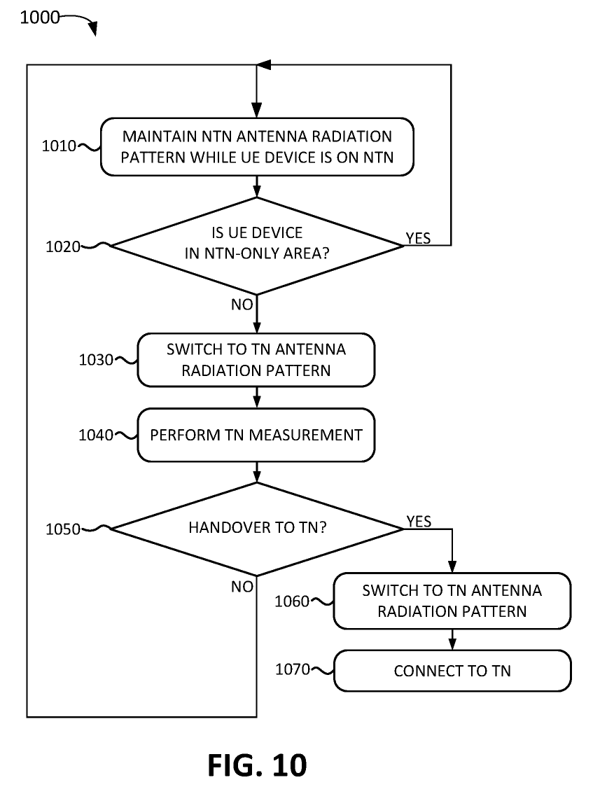

FIG. 10 illustrates a flowchart for a process 1000 of switching from an NTN antenna radiation pattern to a TN antenna radiation pattern according to an implementation described herein. In some implementations, the process of FIG. 10 may be performed by UE device 110. In other implementations, some or all of the process of FIG. 10 may be performed by another device or a group of devices separate from UE device 110.

Process 1000 may include maintaining an NTN antenna radiation pattern while the UE device is on an NTN (block 1010). For example, when UE device 110 is connected to satellite 115 (e.g., attached to satellite 115, registered with satellite 115, etc.), UE device 110 may maintain NTN radiation pattern 320.

A determination may be made as to whether the UE device is in an NTN-only area (block 1020). As an example, UE device 110 may determine whether an NTN-only area geofence has been crossed and/or whether UE device 110 is located in an area that is inside an NTN-only area geofence. UE device 110 may detect an NTN-only area geofence by receiving an alert from core network 150 based on the location of UE device 110 reported to core network 150; by receiving an internal alert from an application or service, running on UE device 110, that is configured with an NTN-only area geofence database; and/or based on receiving another type of indication that UE device 110 is located in an NTN-only area.

If it is determined that the UE device is in an NTN-only area (block 1020 – YES), processing may return to block 1010 to maintain the NTN antenna radiation pattern while the UE device is on the NTN. If it is determined that the UE device is not in an NTN-only area (block 1020 – NO), processing may proceed to switch to a TN antenna radiation pattern (block 1030) and performing a TN measurement (block 1040). For example, at particular measurement intervals, UE device 110 may switch from NTN antenna radiation pattern 320 to TN antenna radiation pattern 310, perform a signal strength and/or quality measurement, and send a measurement report to base station 120. UE device 110 may switch back to NTN antenna radiation pattern 320 during the measurement gap.

A determination may be made as to whether a handover to the TN is to be performed (block 1050). For example, UE device 110 may receive an instruction from satellite 115 to perform a handover (or a redirect) to base station 120. If it is determined that the handover to the TN is to be performed (block 1050 – YES), processing may proceed to switch to a TN antenna radiation pattern (block 1060), and connecting to the TN (block 1070). For example, UE device 110 may switch from NTN antenna radiation pattern 320 to TN antenna radiation pattern 310 and may perform a handover or redirect from the NTN to the TN by connecting to base station 120 and disconnecting from satellite 115. If it is determined that the handover to the TN is not to be performed (block 1050 – NO), processing may return to block 1010 to maintain the TN antenna radiation pattern while the UE device is on the TN.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 8, 9, and 10, the order of the blocks and/or signals may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code--it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises” / “comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store, or employ personal information of individuals, it should be understood that such information shall be collected, stored, and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article "a" is intended to include one or more items. Further, the phrase "based on" is intended to mean "based, at least in part, on" unless explicitly stated otherwise.

What is claimed is:

1. A method comprising:
obtaining, by a user equipment (UE) device, tracking information for a Non-Terrestrial Network (NTN) satellite that provides cellular wireless service for UE devices;
determining, by the UE device, a location for the UE device;
determining, by the UE device, an orientation of the UE device;
selecting, by the UE device, an NTN antenna radiation pattern, for an antenna of the UE device, based on the obtained tracking information, the determined location for the UE device, and the determined orientation of the UE device;
controlling, by the UE device, the antenna of the UE device to generate the selected NTN antenna radiation pattern; and
receiving, by the UE device, wireless signals from the NTN satellite via the antenna of the UE device using the generated NTN antenna radiation pattern.

2. The method of claim 1, wherein the antenna of the UE device includes:
a first antenna element corresponding to at least one of a planar inverted-F antenna (PIFA) element or a monopole antenna element; and
a second antenna element corresponding to at least one of a planar L-shaped element or a monopole antenna element, wherein the second antenna element is shorter than the first antenna element and located substantially parallel to the first antenna element.

3. The method of claim 2, wherein controlling the antenna of the UE device to generate the selected NTN antenna radiation pattern includes:
applying power to the second antenna element to perturb a radiation pattern associated with the first antenna element.

4. The method of claim 2, wherein the antenna of the UE device further includes:
a third antenna element corresponding to at least one of a planar L-shaped element or a monopole antenna element, wherein the third antenna element is shorter than the first antenna element and located substantially parallel to the first antenna element and inline with the second antenna element.

5. The method of claim 2, wherein the antenna of the UE device further includes:
a third antenna element corresponding to at least one of a planar L-shaped element or a monopole antenna element; and
a fourth antenna element corresponding to at least one of a planar L-shaped element or a monopole antenna element, wherein the fourth antenna element is shorter than the third antenna element and located substantially parallel to the third antenna element, wherein a planar orientation of the third and fourth antenna elements is perpendicular to a planar orientation of the first and second antenna elements.

6. The method of claim 1, further comprising:
tracking a position of the NTN satellite over a time period; and
adjusting the NTN antenna radiation pattern over the time period based on the tracked position of the NTN satellite.

7. The method of claim 1, further comprising:
maintaining a Terrestrial Network (TN) antenna radiation pattern when the UE device is connected to a TN, wherein the TN antenna radiation pattern is controlled without applying a perturbation based on the tracking information for the NTN satellite.

8. The method of claim 7, further comprising:
switching to the NTN antenna radiation pattern to measure a signal strength or quality associated with the NTN satellite; and
switching back to the TN antenna radiation pattern during a measurement gap associated with the NTN satellite.

9. The method of claim 7, further comprising:
detecting that the UE device has entered an NTN-only coverage location;
switching to the NTN antenna radiation pattern, based on detecting that the UE device has entered the NTN-only coverage location; and
connecting to the NTN satellite using the NTN antenna radiation pattern.

10. The method of claim 9, wherein detecting that the UE device has entered the NTN-only coverage location includes:
detecting a geofence associated with the NTN-only coverage area.

11. The method of claim 9, further comprising:
switching to the TN antenna radiation pattern to measure a signal strength or quality associated with the TN; and
switching back to the NTN antenna radiation pattern during a measurement gap associated with the TN.

12. The method of claim 9, further comprising:
detecting that the UE device has exited an NTN-only coverage location;
switching to the TN antenna radiation pattern, based on detecting that the UE device has exited the NTN-only coverage location; and
connecting to the TN using the TN antenna radiation pattern.

13. A user equipment (UE) device comprising:
a processor configured to:
obtain tracking information for a Non-Terrestrial Network (NTN) satellite that provides cellular wireless service for UE devices;
determine a location for the UE device;
determine an orientation of the UE device;
select an NTN antenna radiation pattern, for an antenna of the UE device, based on the obtained tracking information, the determined location for the UE device, and the determined orientation of the UE device;
control the antenna of the UE device to generate the selected NTN antenna radiation pattern; and
receive wireless signals from the NTN satellite via the antenna of the UE device using the generated NTN antenna radiation pattern.

14. The UE device of claim 13, wherein the UE device includes the antenna of the UE device, wherein the antenna of the UE device includes:
a first antenna element corresponding to at least one of a planar inverted-F antenna (PIFA) element or a monopole antenna element; and
a second antenna element corresponding to at least one of a planar L-shaped element or a monopole antenna element, wherein the second antenna element is shorter than the first antenna element and located substantially parallel to the first antenna element.

15. The UE device of claim 14, wherein, when controlling the antenna of the UE device to generate the selected NTN antenna radiation pattern, the processor is further configured to:
apply power to the second antenna element to perturb a radiation pattern associated with the first antenna element.

16. The UE device of claim 13, wherein the antenna of the UE device further includes:
a third antenna element corresponding to at least one of a planar L-shaped element or a monopole antenna element, wherein the third antenna element is shorter than the first antenna element and located substantially parallel to the first antenna element and inline with the second antenna element.

17. The UE device of claim 13, wherein the processor is further configured to:
track a position of the NTN satellite over a time period; and
adjust the NTN antenna radiation pattern over the time period based on the tracked position of the NTN satellite.

18. The UE device of claim 13, wherein the processor is further configured to:
maintain a Terrestrial Network (TN) antenna radiation pattern when the UE device is connected to a TN, wherein the TN antenna radiation pattern is controlled without applying a perturbation based on the tracking information for the NTN satellite.

19. The UE device of claim 13, wherein the processor is further configured to:
switch to the NTN antenna radiation pattern to measure a signal strength or quality associated with the NTN satellite; and
switch back to the TN antenna radiation pattern during a measurement gap associated with the NTN satellite.

20. A non-transitory computer-readable memory device storing instructions executable by a processor, the non-transitory computer-readable memory device comprising:
one or more instructions to obtain tracking information for a Non-Terrestrial Network (NTN) satellite that provides cellular wireless service for UE devices;
one or more instructions to determine a location for the UE device;
one or more instructions to determine an orientation of the UE device;
one or more instructions to select an NTN antenna radiation pattern, for an antenna of the UE device, based on the obtained tracking information, the determined location for the UE device, and the determined orientation of the UE device;
one or more instructions to control the antenna of the UE device to generate the selected NTN antenna radiation pattern; and
one or more instructions to receive wireless signals from the NTN satellite via the antenna of the UE device using the generated NTN antenna radiation pattern.
